(19) United States
(12) Patent Application Publication
(10) Pub. No.: US 2015/0250160 A1
(43) Pub. Date: Sep. 10, 2015

(54) Automatic Scent Dispersion Device

(71) Applicants: Rodney LeRoy Irons, Hesperia, MI (US); Randall Scott Irons, Traverse City, MI (US); Steven Lynnell Irons, Niles, MI (US); Troy Allen Roberson, Hesperia, MI (US)

(72) Inventors: Rodney LeRoy Irons, Hesperia, MI (US); Randall Scott Irons, Traverse City, MI (US); Steven Lynnell Irons, Niles, MI (US); Troy Allen Roberson, Hesperia, MI (US)

(21) Appl. No.: 14/203,558

(22) Filed: Mar. 10, 2014

(51) Int. Cl. A01M 31/00; B05B 11/00

(52) U.S. Cl. CPC A01M 31/008; B05B 11/3052; A01M 31/00

(57) ABSTRACT

An automatic scent dispersion device for providing an automatic scent dispersion system that automatically disperses hunting, cover, and training scent. The automatic scent dispersion device generally includes a waterproof case which houses the motor driven pump which derives its power from the battery source that delivers the power first to the switch which in turn delivers the power to the circuit board mounted precise angle sensor and when the precise angle switch circuit is open the self-priming pump is engaged which causes fluid to pass from the reservoir bottle through the rubber pick up line, through the prime relief T connector, into the pump and out the dispersion hose and exiting the dispersion nozzle.

This application claims priority from provisional application No. 61/776,741, filed Mar. 11, 2013, for Automatic Scent Dispersion Device.

### FIELD OF THE INVENTION

The present invention relates generally to a liquid hunting, cover and training scent disbursement system. More specifically it provides a user controlled apparatus to disperse hunting scent, cover scent, and training scent, which is deployed on a user's person and sprays a concentrated stream of liquid hunting scent, cover scent and training scent to aid and assist in covering a hunters human scent trail, creating a scent trail used for luring wild game, and for captive animal training purposes.

### BACKGROUND OF THE INVENTION

In the hunting and animal training industry it has forever been a concept to use scent trails and cover scent trails to aid and assist in either luring or training animals to adhere to the persons desires.

One such method is the use of scent pads in which a user applies scent to an elastic banded applicator, affixes this over their boot once scent is applied and walks to their respective spot where they lie in wait. This particular method leads to many complications to the hunter in all aspects do to the nature of affixing the apparatus to their boot, applying scent once this achieved and also the fact that the scent trail typically only will last for approximately twenty three yards due to earthly interference. Contamination is also an issue for the hunter or trainer once they reach their respective position when removing such said apparatus.

Other forms of prior art indicate the use of scent drag lines. The device is affixed to the user by either means of a rope or strap, saturated in scent and drug behind the user as they navigate their coordinates to their respective area. Although effective, earthly interference once again affects this method and renders it obsolete after approximately nineteen yards of use. The device also is known to become entangled repeatedly as one walks to their desired location.

Other methods such as the liquid animal scent dispenser, although similar in end results, can possess other complications to the user. In the aforementioned apparatus, the use of a manually primed pump is deployed. The user must physically prime the scent dispersal system, which can lead to user contamination, or possible wasted scent. Also, a ventilation cap is used in the liquid animal scent dispenser for the relief of the vacuum of the fluid flow. While in theory, the concept is necessary, it is more effective to have a user controlled option which will allow the prime to be released manually after the desired scent disbursement effect is reached. Also to be noted, the liquid animal scent dispenser has three possible modes of operation. It has a manual mode which once triggered by the user, will adapt and spray scent according to the user's walking pattern, an automatically timed mode, and a possible stationary motion activated mode. Many hunters or trainers will desire the option to activate the dispenser on command, due in part to a desire to begin and also end a scent trail at a specific location without the need for a continuous trail provided by a continuous walking pattern.

Therefore, it is desired for an approved apparatus and method to automatically disperse liquid scent for hunting, cover and training purposes.

### OBJECTS OF THE INVENTION

It is an object of this invention to provide a self priming, automatic hunting, cover, and training scent disbursement system that is activated at a precise angle as defined by the user's adjusted walking pattern, at the user's discretion, and a method in which also will allow the user to end the flow of said liquid scent once the desired location is reached.

Still other objects and advantages of the invention will in part be obvious and will in part be apparent from the specification and drawings.

### SUMMARY OF THE INVENTION

In accordance with the invention, a method and apparatus are provided which will allow the user to automatically disperse hunting, cover, and training scent without the need to prime the apparatuses system and which will allow the user to determine when said scent is disbursed by acquiring a precise angle depicted by the users walking pattern and the ability to break the prime of said liquid scent when the user determines this function is necessary.

Also, in accordance with the invention, an automatic scent dispersal system in it's broadest context will consist of an embodiment which will house a power source, a self priming electric pump, a circuit board, a precise angle switch, a power switch, a pick up line connecting the external reservoir, a prime relief T connector, and a dispersion nozzle.

The invention accordingly comprises the several steps and the relation of one or more of such steps with respect to each of the others, and the apparatus embodying features of construction, combinations of elements and arrangement of parts that are adapted to affect such steps, all is exemplified in the following detailed disclosure, and the scope of the invention will be indicated in the claims.

### BRIEF DESCRIPTION OF THE DRAWINGS

FIG. 1 is a three dimensional side view of the completed automatic dispenser unit as a whole.

FIG. 2 is the completed automatic dispenser unit with the housing cover removed, and cutaways to provide detail in the function of the dispenser components.

FIG. 3 is an exploded view of the 4.5-8 VDC micro motor and the self-priming pump which it controls.

FIG. 4 is an exploded view of the precise angle switch.

FIG. 5 is an exploded view of the circuit board which will bridge the electrical connection of the main components.

FIG. 6 is an exploded view of the 12 VDC main power supply on and off switch.

FIG. 7 is a schematic view of the power supply circuit which defines the power delivery of the dispenser.

### DETAILED DESCRIPTION OF THE PREFERRED EMBODIMENTS

Turning now descriptively to the drawings, in which similar reference characters denote similar elements throughout the several views, the figures illustrate a water-proof case which houses the motor driven self-priming pump which derives its power from the battery source that delivers the power first to the switch which in turn delivers the power to the circuit board precise angle switch and when the precise angle switch circuit is open the self-priming pump is engaged which causes fluid to pass from the reservoir bottle through the rubber pick up line, into the pump and out the dispersion hose and exiting the dispersion nozzle.

Waterproof Case:

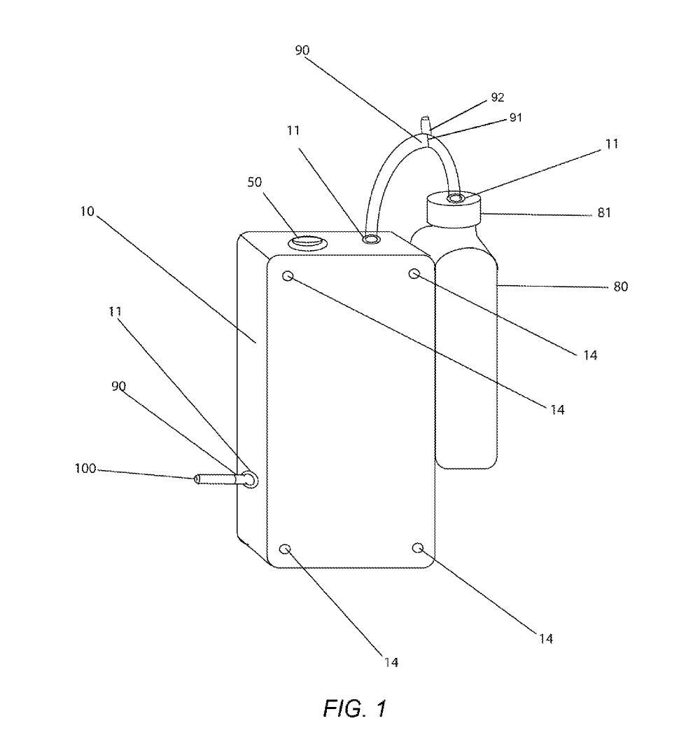

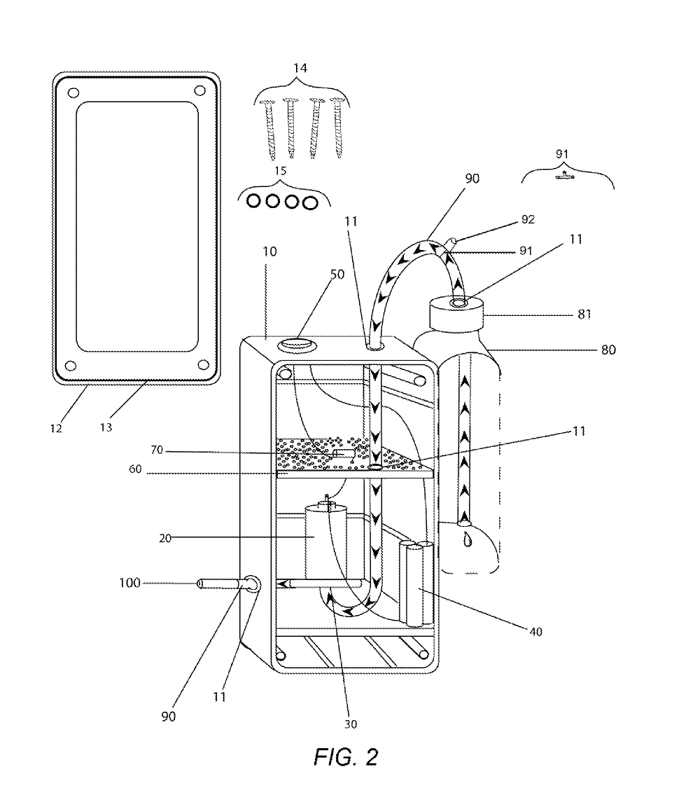

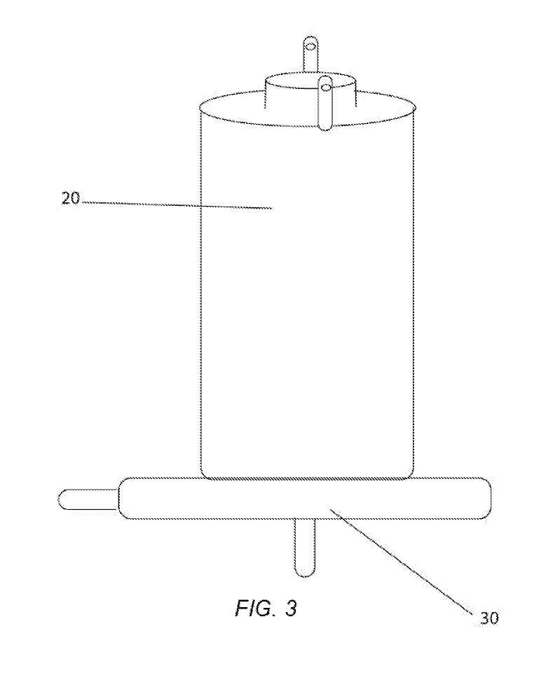

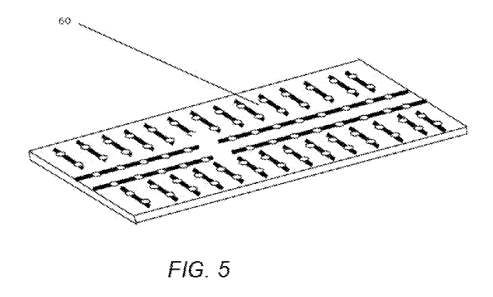

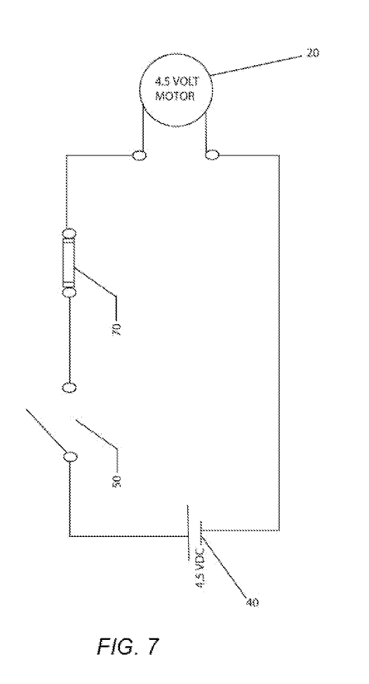

The structure of the ABS waterproof case (10) (FIG. 1, FIG. 2), is an ABS waterproof plastic case measuring 2″ deep, by 2 1/2″ wide, by 5″ tall. It's purpose it to house the main components for the scent disperser. Inside the case there is mounting grooves for other main components such as the circuit board (60) (FIG. 2, FIG. 5) and the motor (20) (FIG. 2, FIG. 3), and the self-priming pump (30) (FIG. 2, FIG. 3). Inside it will house the battery power source (40) (FIG. 2, FIG. 7) portions of the pick up and dispersion line (90) (FIG. 1, FIG. 2). The ABS plastic waterproof case (10) (FIG. 1, FIG. 2) also contains the following sub-elements which are the four 1/8″ screws (14) (FIG. 1, FIG. 2), the four 1/8″ rubber o-rings (15) (FIG. 2) and two 3/8″ rubber grommets (11) (FIG. 1, FIG. 2).

The water proof case (10) (FIG. 1 and FIG. 2), could possibly be improved on by down sizing the unit when internal components such as the motor (20) (FIG. 2 and FIG. 3, FIG. 7) is developed in smaller magnitude. Also the battery power source (40) (FIG. 2, FIG. 7) could be changed with many different configurations to allow for the proper voltage and amperes to be received in the circuit (60) (FIG. 7).

Motor:

The motor (20) (FIG. 2, FIG. 3, FIG. 7), is a 1 1/8″ diameter by 1 1/4″ tall 4.5 VDC-8 VDC motor. It's function is to drive the self-priming pump (30) (FIG. 2, FIG. 3). It has the capabilities to move 2 gallons of fluid per minute.

The motor (20) (FIG. 2, FIG. 3, FIG. 7) could be improved upon if another motor of smaller magnitude is developed.

Self-Priming Pump:

The self-priming pump (30) (FIG. 2, FIG. 3) is made of industrial plastic. It's function is to create a vacuum which draws fluid from the reservoir bottle (80) (FIG. 1, FIG. 2) up the pick up hose (90) (FIG. 1, FIG. 2) through the prime relief T connector, into the self-priming pump (30) (FIG. 2, FIG. 3) out the dispersion hose (90) (FIG. 1, FIG. 2) and to disperse fluid out the dispersion nozzle (100) (FIG. 1, FIG. 2).

The self-priming pump (30) (FIG. 2, FIG. 3) could be improved on if they can develop a smaller self-priming pump in magnitude. Other variants that could be utilized would be internal motor driven pumps.

Battery Power Source:

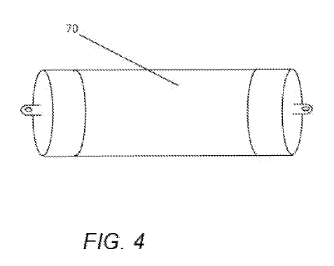

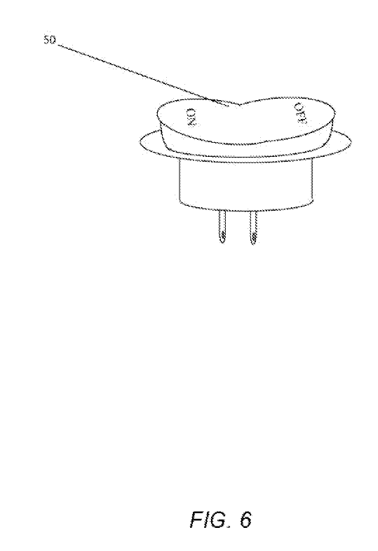

The battery power source (40) (FIG. 2, FIG. 7) is 4.5 VDC and is provided by three AAA batteries. Its function is to provide power to the switch (50) (FIG. 1, FIG. 2, FIG. 6, FIG. 7), the precise angle switch (70) (FIG. 2, FIG. 4, FIG. 7), and the motor (20) (FIG. 2, FIG. 3, FIG. 7).

The battery power source (40) (FIG. 2, FIG. 7) could be improved upon by using smaller variations of power supply to equal the desired amperes and voltage. Other variations could include means of power supply by kinetic energy.

Switch:

The switch (50) (FIG. 1, FIG. 2, FIG. 6, FIG. 7) is a 10 amp/12 VDC switch. It's function is to control power provided by the battery power source (40) (FIG. 2, FIG. 7) by means of either an open or closed circuit.

The switch (50) (FIG. 1, FIG. 2, FIG. 6, FIG. 7) is an non-illumination switch. Different variations could include glow in the dark technology, or light provided by kinetic energy.

Circuit Board:

The circuit board (60) (FIG. 2, FIG. 5) measures 2 3/8″ wide by 1 3/4″ deep. Its function is to provide a bridge for the main electrical components of the battery power source (40) (FIG. 2, FIG. 7) the precise angle switch (50) (FIG. 1, FIG. 2, FIG. 6, FIG. 7) the sensor (70) (FIG. 2, FIG. 4, FIG. 7) and the motor (20) (FIG. 2, FIG. 3, FIG. 7).

The circuit board (60) (FIG. 2, FIG. 5) could be down sized in the future when smaller technology also becomes available.

Precise Angle Switch:

The precise angle switch (70) (FIG. 2, FIG. 4, FIG. 7) is cylindrical in shape measuring 3.3 millimeters×6.9 millimeters. The function of the precise angle switch (70) (FIG. 2, FIG. 4, FIG. 7) is to bridge power supplied by switch (50) (FIG. 1, FIG. 2, FIG. 6, FIG. 7) to the motor (20) (FIG. 2, FIG. 3, FIG. 7) by means of obtaining the desire angle of 7.5 degrees by the user.

The precise angle switch (70) (FIG. 2, FIG. 4, FIG. 7) could be changed by using other variations which could include timing devices operating the scent dispenser.

Reservoir Bottle:

The structure of the reservoir bottle (80) (FIG. 1, FIG. 2) is plastic. It measures 2 1/8″ wide by 1 1/4″ deep by 4 1/8″ tall. It's function is to provide containment of scent and cover scent products. The universal adaptation cap (81) (FIG. 1, FIG. 2) is also a sub-element of the reservoir bottle (80) (FIG. 1, FIG. 2).

The reservoir bottle (80) (FIG. 1, FIG. 2) can be changed by the user to any size desired. The 3/4″ Outside Diameter Universal Adaptation Cap (81) (FIG. 1, FIG. 2), is the common size for previous manufactured hunting scent and cover scent products. Any cap that can be drilled through could house one of the 3/8 rubber grommet (11) (FIG. 1, FIG. 2).

Pickup and Dispersion Hose:

The pickup and dispersion hose (90) (FIG. 1, FIG. 2) is comprised of a 5/16″ rubber hose and the prime relief T connector (91). The inside diameter measures 1/8″. It's function is to deliver fluid from the reservoir bottle (80) (FIG. 1, FIG. 2) through the pickup hose (90) (FIG. 1, FIG. 2) through the prime relief T connector (91) to the pump (30) (FIG. 2, FIG. 3) out the dispersion hose (90) (FIG. 1, FIG. 2) and exiting the fluid out the dispersion nozzle (100) (FIG. 1, FIG. 2).

Plastic tubing could be used in place of the pickup and dispersion Hose (90) (FIG. 1, FIG. 2).

Dispersion Nozzle:

The dispersion nozzle (100) (FIG. 1, FIG. 2) is comprised of capillary tubing measuring 1/8″ in diameter. The exterior end of the dispersion nozzle has a precision hole drilled at 0.072″. The function of the dispersion nozzle is to pressurize and limit the flow of fluid delivered from the dispersion hose (90) (FIG. 1, FIG. 2) and the self-priming pump (30) (FIG. 2, FIG. 3).

Different variations of the Dispersion Nozzle (100) (FIG. 1, FIG. 2) could be those consisting of an adjustable spray nozzle and a possible internal pin similar to air brush paint guns currently on the market.

Connection of Main Elements and Sub-Elements of the Invention:

The case (10) (FIG. 1, FIG. 2) houses the main components of the battery power supply (40) (FIG. 2, FIG. 7) the self-priming pump (30) (FIG. 2, FIG. 3) the motor (20) (FIG. 2, FIG. 3, FIG. 7) the circuit board (60) (FIG. 2, FIG. 5) the precise angle switch (70) (FIG. 2, FIG. 4, FIG. 7) and the dispersion hose (90) (FIG. 1, FIG. 2).

Externally the fluid reservoir bottle (80) (FIG. 1, FIG. 2) and the 3/4″ outside diameter universal adaption cap (81) (FIG. 1, FIG. 2) house the removable pickup hose, the prime relief T connector (91), and dispersion hose (90) (FIG. 1, FIG. 2) which passes through the 3/8″ grommet (11) (FIG. 1, FIG. 2) which is mounted in the top of the 3/4″ outside diameter universal adaption cap (81) (FIG. 1, FIG. 2) through another 3/8″ grommet (11) (FIG. 1, FIG. 2) then through the case (10) (FIG. 1, FIG. 2) through another 3/8″ (11) (FIG. 1, FIG. 2) grommet inside the circuit board (60) (FIG. 2, FIG. 5) and connects to the self-priming pump (30) (FIG. 2, FIG. 3) The dispersion hose (90) (FIG. 1, FIG. 2) is connected to the self-priming pump (30) (FIG. 2, FIG. 3) and passes through a 3/8″ grommet (11) (FIG. 1, FIG. 2) mounted to the side of the case (10) (FIG. 1, FIG. 2) then connects to the dispersion nozzle (100) (FIG. 1, FIG. 2)

Internally inside the case (10) (FIG. 1, FIG. 2) the battery power supply (40) (FIG. 2, FIG. 7) connects the positive wire to the case mounted switch (50) (FIG. 1, FIG. 2, FIG. 6, FIG. 7) another positive wire runs from the opposite side of the switch (50) (FIG. 1, FIG. 2, FIG. 6, FIG. 7) to the precise angle switch (70) (FIG. 2, FIG. 4, FIG. 7). on the outgoing side of the precise angle switch (70) (FIG. 2, FIG. 4, FIG. 7) another positive wire runs down and connects to the positive side of the motor (20) (FIG. 2, FIG. 3, FIG. 7) on the other side of the motor (20) (FIG. 2, FIG. 3, FIG. 7) a ground is connected and ran back to the battery power supply (40) (FIG. 2, FIG. 7) completing the circuit. the case (10) (FIG. 1, FIG. 2) is water proofed by adding the case cover (12) (FIG. 1, FIG. 2) and the internal O-ring (13) (FIG. 2) then applying the four 1/8″ O-rings (15) (FIG. 2) onto the four 1/8″ screws (14) (FIG. 1, FIG. 2).

### OPERATION OF THE PREFERRED EMBODIMENT

User disconnects the pickup line (90) at the prime relief T connector (91) and unscrews the 3/4″ Outside Diameter Universal Cap (81) and fills the reservoir bottle (80) with desired hunting or cover scent.

User then replaces the 3/4″ Outside Diameter Universal Cap (81) onto the reservoir bottle (80) reconnects the pickup hose (90) to the prime relief T connector (91) and ensures the pickup Hose (90) is seated at the bottom of the reservoir bottle (80).

User will affix the scent disperser to their ankle with the provided carrying pouch. User can choose when to activate the automatic scent disperser by providing power with the switch (50). Since the Battery Power Source (40) is constant, once the switch (50) is activated, power is supplied to the precise angle switch (70) The precise angle switch consists of a hollow container containing two steel metal balls which are precisely machined so that when a user walks and desires scent disbursement, if the user plants their heal first before the sole of their foot, they will achieve a 7.5 degree angle which is required for the precise angle switch (70) to activate. This allows the user to have power only supplied when desired. When the user makes the heal of their foot make contact with the ground, the power circuit (FIG. 7) will be completed (open) by the precise angle switch (70) and power will be passed to the motor (20) which will engage the self-priming pump (30).

Once the self-priming pump (30) is engaged, a vacuum is created inside the pickup Hose (90) and the self-priming pump (30). This allows for fluid inside the reservoir bottle (80) to pass through the pickup hose (90) and be delivered to the self-priming pump (30) once the fluid enters the self-priming pump (30) it is passed through the dispersion hose (90) and pushed out the dispersion nozzle (100). With the use of the precise angle switch (70), when the user is at a stopped state, the unit will not activate until 7.5 degrees is once again applied. With the use of this type of precise angle switch (70), the Battery Power Source (40) will provide many hours of use since its active state is determined by the user and the activation of the precise angle switch (70) and power is only briefly supplied by the battery power source (40).

By the use of the 3/4″ outside diameter universal cap (81) users can make use of the many name brand hunting and cover scents provided on today's market since most companies use the same particular cap size. If the user prefers, they have the option to fill the provided reservoir bottle (80) with the hunting, cover, or training scent of their choice.

When user reaches their destination of choice, user will remove the prime relief T connector cap (92) which will allow the units liquid prime to be broken and stop the flow of fluid. User will tilt the scent disperser (FIG. 1) until the remaining liquid in the pickup hose (90) is clear, replace the prime relief T connector cap (92) and power off the unit (FIG. 1) with the switch (50).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed:

1. An automatic scent dispersion device compromising:
an electric circuit consisting of a switch
a reservoir for liquid scent
a discharge nozzle for dispersing the liquid scent
an electric motor driven pump
a power source
an on/off 12 VDC switch
an enclosure for housing said components

2. The method of claim 1 further comprising wherein the power provide switch is a simple 12 VDC on/off switch

3. The method of claim 2 further comprising of an external reservoir for liquid scent

4. The method of claim 3 further comprising of a prime relief T connector

5. The method of claim 4 further comprising of a precise angle switch located internally in the electric circuit

6. The method of claim 5 further comprising of a self-priming electric pump

7. The method of claim 6 further comprising of a discharge nozzle manufactured from capillary tubing
